(19) United States
(12) Patent Application Publication
(10) Pub. No.: US 2016/0245502 A1
(43) Pub. Date: Aug. 25, 2016

(54) LIGHTED ARCHITECTURAL PANEL SYSTEM

(71) Applicant: Cambridge International Inc., Cambridge, MD (US)

(72) Inventor: Thomas Claude ROSS, Fruitland, MD (US)

(73) Assignee: Cambridge International Inc., Cambridge, MD (US)

(21) Appl. No.: 15/050,987

(22) Filed: Feb. 23, 2016

Related U.S. Application Data
(60) Provisional application No. 62/119,501, filed on Feb. 23, 2015.

(51) Int. Cl. F21V 33/00; F21V 3/04

(52) U.S. Cl. CPC F21V 33/006; F21V 3/049; F21Y 2101/02

(57) ABSTRACT

A lighted architectural panel system includes an architectural panel; a light source panel; and a diffusion panel disposed between the architectural panel and the light source panel.

### TECHNICAL FIELD

The disclosure herein relates to an architectural panel, and more particularly, to an architectural panel system having a light element therein, and a method of making the same.

### BACKGROUND

Architectural panels such as those made from a rigid mesh are generally used in commercial and business environments to provide elegant wall panels, doors and other surfaces whenever an aesthetic appearance of polish and prestige are of primary importance. Architectural mesh is also an excellent choice for high contact areas, such as the interior walls of elevator cabs, escalator walls, and sales and reception areas, because it is generally scratch, dent and corrosion resistant. As such, architectural mesh maintains a stunning appearance with minimal maintenance. Architectural mesh panels can also be used to provide protection from the wind and other elements such as, for example, in a parking garage where the exterior walls are only several feet high on each level, thus leaving a several foot open area through which rain and sleet can enter the garage.

Woven into panels from brass, stainless steel, copper, and/or other desired metals or alloys, or combinations thereof, architectural metallic mesh offers a richness of texture, pattern and color that cannot be duplicated by any other material. Depending upon the chosen weave, the interstices or apertures between the weft or fill wires and the warp wires may allow light to pass through the architectural mesh. There is difficulty in achieving a consistent light pattern, however, if the weave pattern is tight or the interstices are not spaced in a consistent pattern.

U.S. Pat. No. 6,793,360 assigned to Cambridge International Inc., the contents of which are hereby incorporated herein, discloses an example of an architectural mesh panel wherein a light element is interwoven with the plurality of wires in the mesh. The result is an attractive and decorative mesh panel with accent light effects therethrough. The type of mesh panel disclosed in this patent includes woven weft and fill wires and the light element is substituted for one of the weft wires during the manufacture of the mesh. While this type of interweaving securely holds the light element in place, repair or replacement of the light element may be quite difficult and labor intensive and the pattern of light provided is fixed so that it cannot be changed or altered.

Accordingly, it would be desirable to provide an architectural panel having a light element therein, so as to create a greater aesthetic appeal in environments benefitted by the presence of accent lighting, wherein the light element is more readily accessible, replaceable, and/or interchangeable as desired.

### SUMMARY OF THE INVENTION

The disclosure herein provides a lighted architectural panel system comprising an architectural panel, a light source panel, and a diffusion panel disposed between the architectural panel and the light source panel.

### BRIEF DESCRIPTION OF THE FIGURES

These, and other objects, features, and advantages of the disclosure will become more readily apparent to those skilled in the art upon reading the following detailed description, in conjunction with the appended drawings in which:

FIG. 1 is an exploded perspective view of a lighted architectural panel system in accordance with an exemplary embodiment of the disclosure herein.

FIG. 2 is a front view of an exemplary embodiment of an architectural mesh panel.

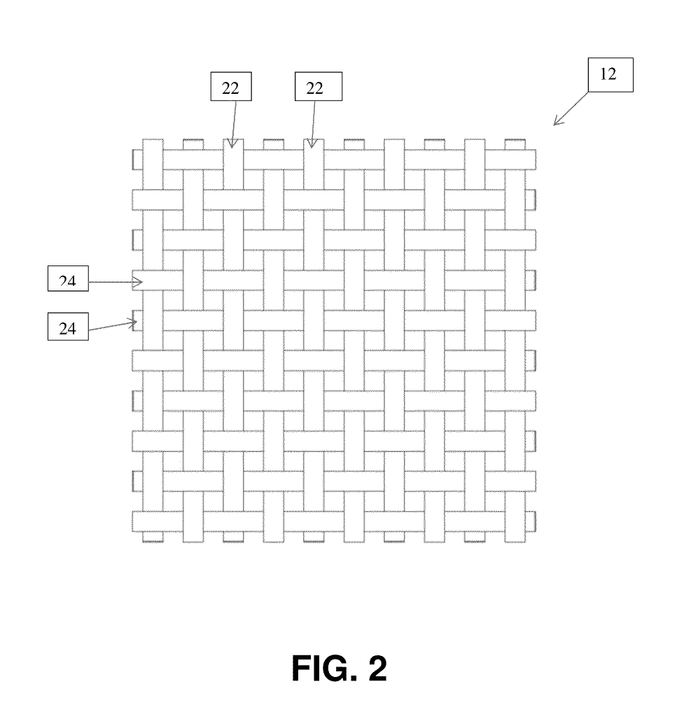

FIG. 3 is a front view of an exemplary embodiment of an interchangeable backer plate with LED lighting.

FIG. 4 is a cross section taken generally along line A-A shown in FIG. 3.

FIG. 5 is an enlarged view of Detail C shown in FIG. 3.

FIG. 6 is an enlarged view of Detail B shown in FIG. 4.

FIG. 7 is an exploded perspective view of an architectural panel system in accordance with a further exemplary embodiment of the disclosure.

FIG. 8 is an exploded perspective view of an architectural panel system in accordance with a still further exemplary embodiment of the disclosure.

### DETAILED DESCRIPTION OF THE PREFERRED EMBODIMENTS

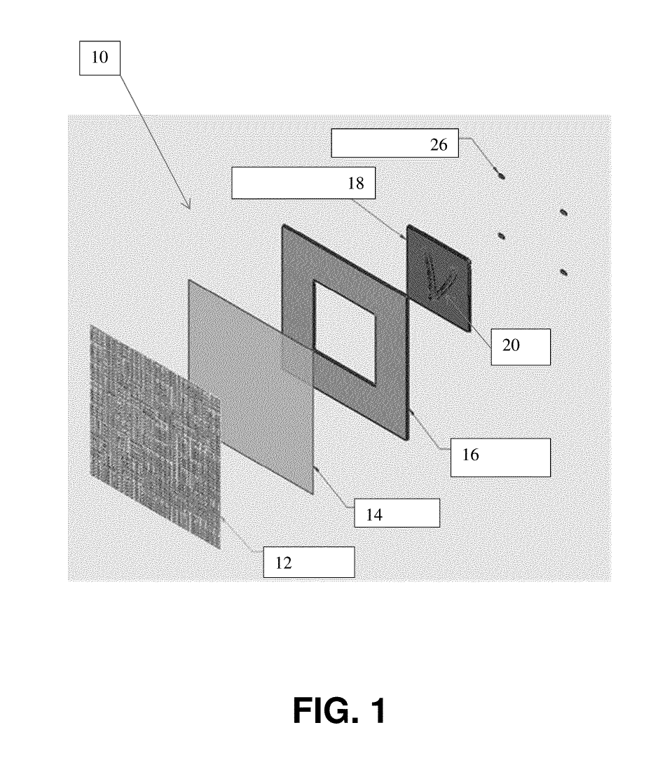

A lighted architectural mesh panel system in accordance with an exemplary embodiment of the disclosure is shown generally in FIG. 1 by reference numeral 10. The architectural mesh panel system 10 preferably includes an architectural mesh panel 12, a diffusion panel 14, an outer backer board frame 16, and an interchangeable backer board 18 including a lighting system 20. The various components of the architectural panel system 10 are secured together by known attachment hardware 26.

The mesh panel 12 is woven from a combination of wires of two or more different metals, for example, brass and stainless steel, or the mesh may be woven using wires 22 and 24 that are made from the same metal or other substantially rigid material. All of the wires 22, 24 may be the same size or shape, or they may have different characteristics. The materials most commonly used in rigid metallic mesh are stainless steel, aluminum, brass, bronze and copper. The combination of the different size wires and materials creates a unique texture appearance for architectural metallic mesh.

In the architectural mesh panel 12, the members 22 are strands of wire in the fill or weft direction of weaving and the members 24 are strands of wire in the warp direction. In the illustrated embodiment, the warp members 24 cross under and over the wires 22 in a plain weave. However, it should be apparent to one skilled in the art that other weaves, such as a twill weave or hollander (Dutch) weave, for example, could also be used. The wires 22 and 24 are illustrated in an evenly spaced relation for ease of understanding, and although mesh panel 12 could be so manufactured, the wires could be directly closely adjacent one another, or unevenly spaced, in practice. Thus, the architectural mesh panel 12 is a typical example of a continuously woven metallic mesh having wires 22 in the fill direction and wires 24 in the warp direction.

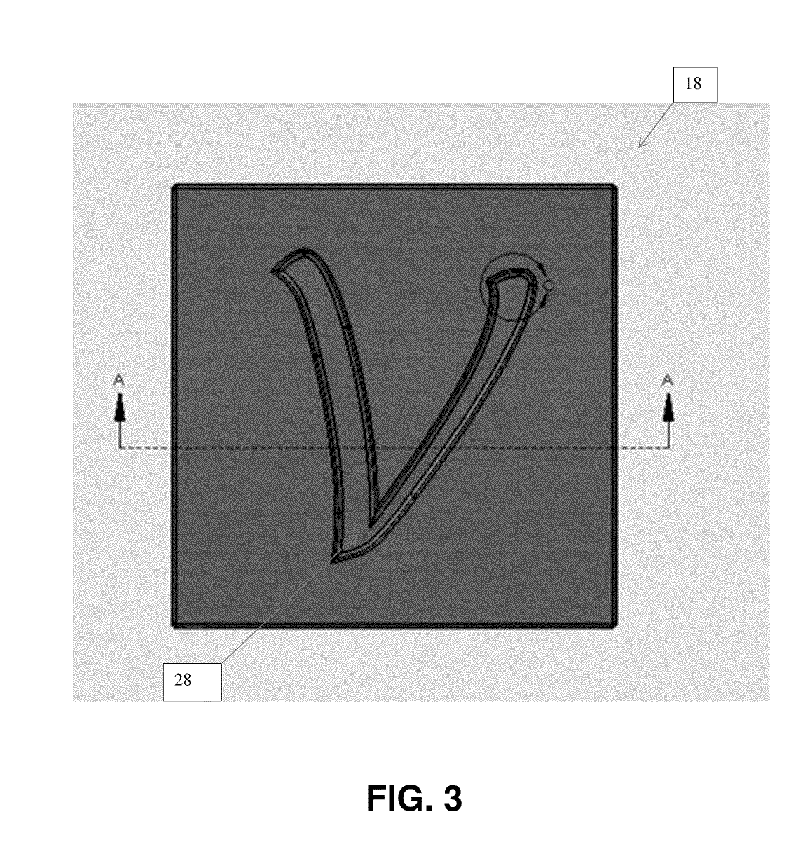

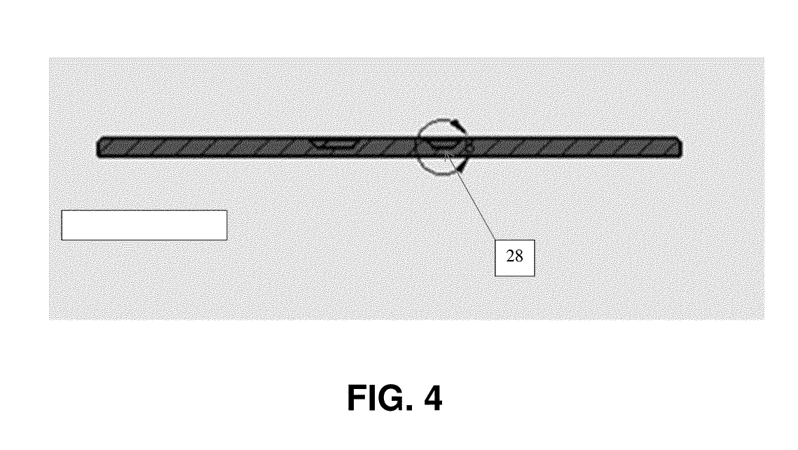

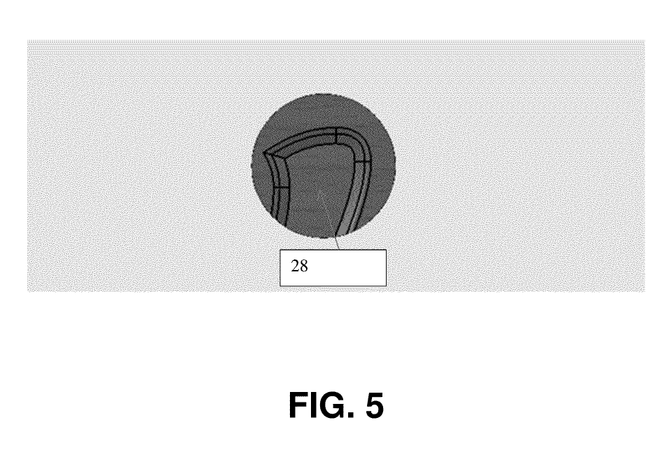

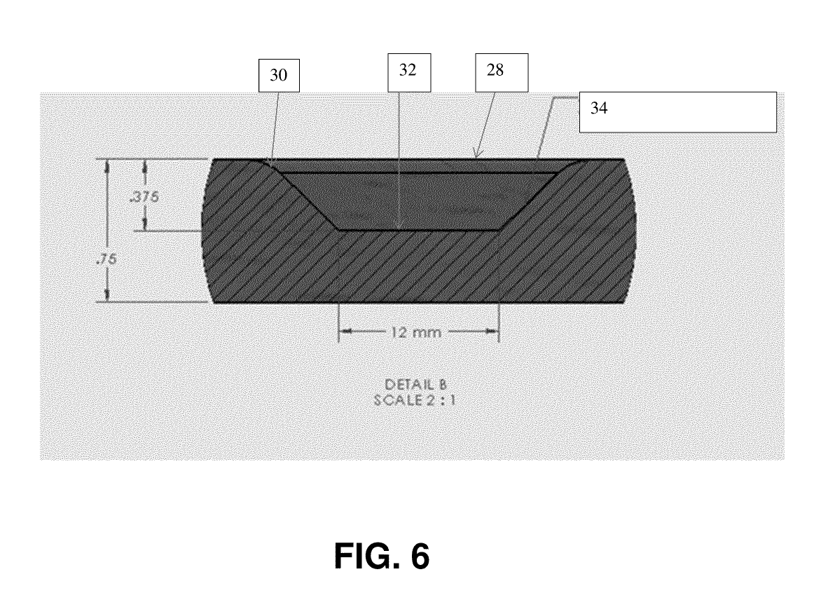

A further element of lighted architectural mesh system 10 is the interchangeable backer board or plate 18 shown in FIG. 3. A backer board frame 16 may optionally be provided for additional support and rigidity, with the interchangeable backer plate 18 being mounted thereon in any known manner. The backer plate 18 contains fluted grooves 28 with clearance to hold the lighting system 20, such as a LED rope light. The grooves 28 may be machined to comprise letters, graphics, or patterns for commercial offerings. A matrix of grooves 28 can also be inlaid to provide a grid of LED elements to allow for more elaborate graphics and media presentations. The grooves 28 allow for the insertion of flexible LED elements 20, thus making the system self-contained. The backer plate 18 is typically painted a dark color with the LED receiving grooves 28 being a lighter color to provide greater contrast and light dispersion. As shown best in FIGS. 4-6, grooves 28 may be formed as a V-shaped groove with a fluted edge 30. The V-shape of the groove 28 as illustrated in the exemplary embodiment includes a flat groove bottom 32 and angled side walls 34 shown at forty degrees, although this angle can be varied. It has been found that this shape of the grooves 28 also assists with light dispersion, but any shape groove capable of securing light element 20 therewithin could of course also be used. The backer plate 18 and backer board frame 16 are typically made from a material such as medium density fiberboard (MDF) for interior use or a polycarbonate material for exterior use. The LED backer plate 18 is designed to be interchangeable, to thus allow for removal and maintenance of the LED lighting 20 or for changing the LED lighting elements to provide different logos or patterns. As such, lighted architectural mesh system 10 can be maintained or changed for different applications without the need to disassemble the entire panel.

An example of such a light element 20 is a flexible light rope or any similarly know elements. The light-emitting diode (LED) can be of any desired color to create the desired light effect. The LEDs may be wired to a power grid or powered by one or more batteries, or otherwise powered as known in the art, and may be configured for either continuous power or flashing on and off for longer life. Still further, the LEDs may be used to create a picture, logos, wording, or even a continuously moving light display. The disclosure here is not limited to the size or shape of the light element 20 shown in the figures, it being clear to one skilled in the art that various sizes and shapes can be used depending upon the size of the recess 28 formed in the backer board 18.

Depending on the chosen weaving pattern, the interstices between the warp and weft wires will allow light to pass through the architectural mesh. There may be difficulty in achieving a consistent light pattern, however, if the weave pattern is tight or the interstices are not spaced in a consistent pattern.

This lighting limitation is overcome by providing diffusion panel 14 between the backer board 18 and the mesh panel 12. The diffusion panel 14 is a translucent panel that may be made of frosted glass, Plexiglas, or any type of plastic which is sandwiched between the outer rigid mesh panel 12 and the LED lighting 20 contained in the interchangeable backer plate 18. The translucent panel 14 distributes the lighting across the back face of the rigid mesh 12. Thus the LED lighting 20 does not have to align or be sized exactly with the mesh openings or pattern. The LED lighting 20 can be triggered by touch, motion sensors, manual controls, or otherwise as dictated by the application.

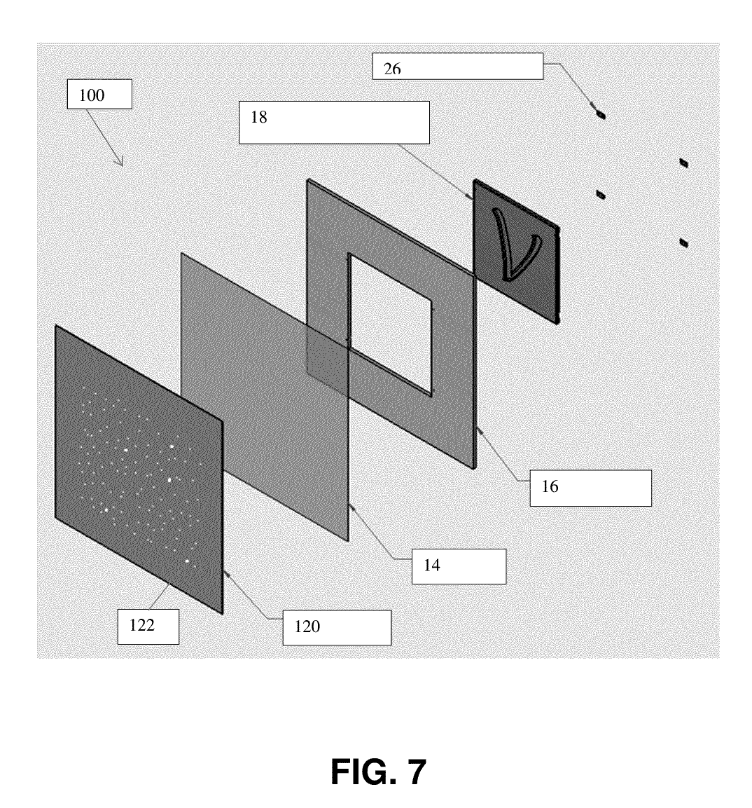

A lighted architectural panel system in accordance with a further exemplary embodiment of the disclosure is shown generally in FIG. 7 by reference numeral 100. The architectural panel system 100 preferably includes an architectural panel 120, a translucent panel 14, an outer backer board frame 16 (optional), and an interchangeable backer board 18 including an LED lighting system 20. Like reference numerals are being used to denote like elements described above relative to the embodiment of FIG. 1. Architectural panel 120 replaces the woven mesh panel 12 and is formed from a perforated metal sheet. The perforations 122 may be provided in any type of symmetrical or random pattern as desired.

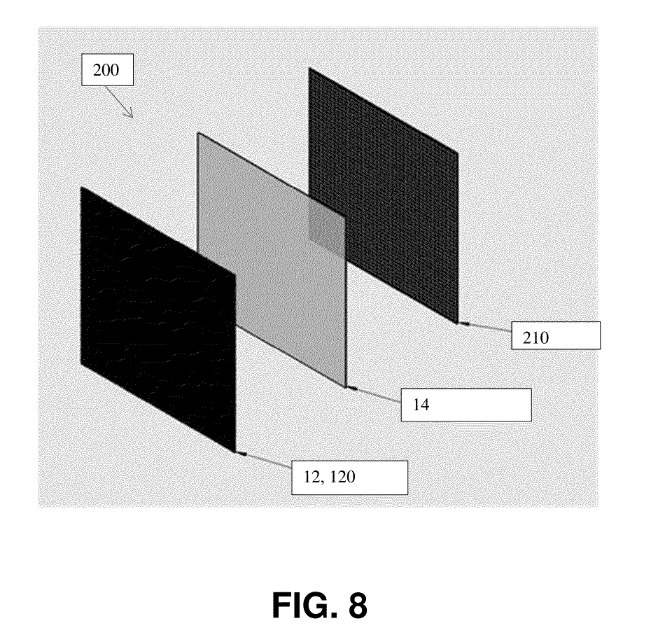

A lighted architectural panel system in accordance with a still further exemplary embodiment of the disclosure is shown generally in FIG. 8 by reference numeral 200. The architectural panel system 200 preferably includes an architectural panel 12, 120, a translucent panel 14, and a printed circuit board (PCB) 210 that can be spot welded to the metal of architectural panel 12, 120, thus eliminating a need for the backer plate or backer plate frame therebetween. The printed circuit board 20 has conductive copper tracks that may be laminated into a non-conductive surface. Electronic components can thus be surface mounted or through-hole mounted, such as LED light elements 220, and the components are connected by the copper tracks to form a circuit.

While the disclosure herein has been described with respect to particular exemplary embodiments of the invention, this is by way of illustration for purposes of disclosure rather than to confine the invention to any specific arrangement as there are various alterations, changes, deviations, eliminations, substitutions, omissions and departures which may be made in the particular embodiment shown and described without departing from the scope of the present invention as defined only by a proper interpretation of the appended claims.

1. A lighted architectural panel system comprising:
an architectural panel;
a light source panel; and
a diffusion panel disposed between said architectural panel and said light source panel.

2. The lighted architectural panel system according to claim 1, wherein said architectural panel is an architectural mesh panel.

3. The lighted architectural panel system according to claim 2, wherein said light source panel includes an interchangeable backer board having a lighting element.

4. The lighted architectural panel system according to claim 4, wherein said light element includes a light-emitting diode.

5. The lighted architectural panel system according to claim 2, wherein said light source panel includes a printed circuit board.

6. The lighted architectural panel system according to claim 2, wherein said a diffusion panel comprises a translucent panel.

7. The lighted architectural panel system according to claim 1, wherein said architectural panel is a perforated metal panel.

8. The lighted architectural panel system according to claim 7, wherein said light source panel includes an interchangeable backer board having a lighting element.

9. The lighted architectural panel system according to claim 4, wherein said light element includes a light-emitting diode.

10. The lighted architectural panel system according to claim 7, wherein said light source panel includes a printed circuit board.

11. The lighted architectural panel system according to claim 7, wherein said a diffusion panel comprises a translucent panel.
